(19) United States
(12) Patent Application Publication
(10) Pub. No.: US 2005/0104535 A1
(43) Pub. Date: May 19, 2005

(54) Driver circuit for an electroluminescent lamp

(76) Inventor: Henricus Cornelis Johannes Buthker, Mierio (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/507,952

(22) PCT Filed: Feb. 25, 2003
(86) PCT No.: PCT/IB03/00759

(30) Foreign Application Priority Data
Mar. 19, 2002 (EP) 02076144.1

(51) Int. Cl. H05B 41/36

(52) U.S. Cl. 315/219; 315/246

(57) ABSTRACT

A driver (1) for an electroluminescent lamp comprises a first current pulse generator (11) for generating at an output (2) current pulses having a first polarity, and a second current pulse generator (21) for generating at the output (2) current pulses having a second polarity opposite the first polarity. A control unit (30) is operatively coupled to the first and second current pulse generators (11, 21), to switch the first and second current pulse generators (11, 21) ON and OFF. The control unit (30) switches both first and second current pulse generators (11, 21) OFF during at least one portion of an output voltage period.

The present invention relates in general to a driver circuit for an electroluminescent lamp. Electroluminescent lamps are for instance used in electroluminescent displays such as used in handheld devices like mobile phones, personal digital assistants, in small mains-fed devices like web terminals and cash terminals, and in automotive applications.

As is commonly known, an electroluminescent lamp is driven by means of an alternating voltage. Although it is possible to drive an electroluminescent lamp with a sine wave voltage, generated by resonant means, it is usually preferred to drive an electroluminescent lamp with square wave voltage, using switches to connect and disconnect a voltage source. In a practical embodiment of a prior art driver circuit, positive current pulses are applied to the driver output during a first half of a voltage period, and negative current pulses are applied to the driver output during a second half of the voltage period. The electroluminescent lamp has a capacitive characteristic, such that the current pulses charge the lamp to a certain voltage. An example of such driver embodiment is disclosed in U.S. Pat. No. 5,349,269. In this prior art device, two inverters have their outputs coupled to different terminals of the electroluminescent lamp. A control circuit controls the operation of the two inverters, such that, alternately, the pulses of the two inverters are applied to the electroluminescent lamp.

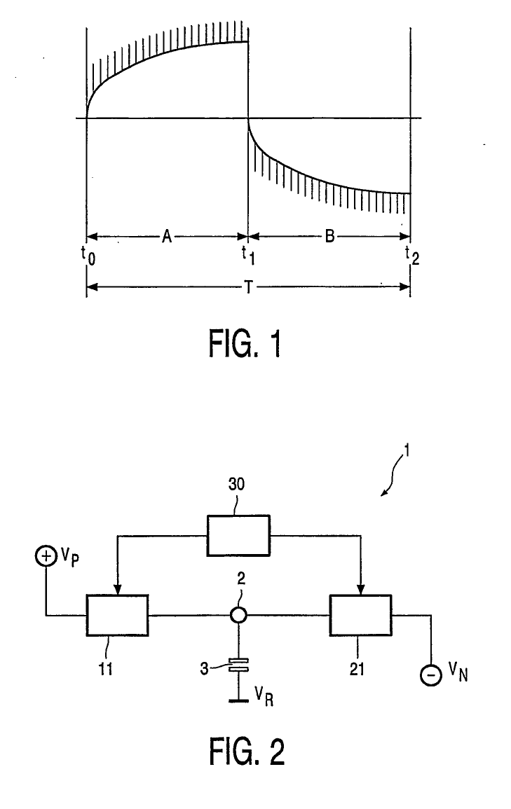

In the prior art driver circuits, it is customary that the current pulses are applied during the entire duration of a voltage period. The resulting waveform of the voltage at the output of the driver circuit, i.e. the lamp voltage, is shown in FIG. 1. In FIG. 1, a voltage period is indicated as T. A first half of the voltage period, during which the lamp voltage has a first polarity, is indicated as A. A second half of the lamp voltage, during which the lamp voltage has an opposite polarity, is indicated as B. In the following, the first polarity will be indicated as positive and the second polarity will be indicated as negative. For easy reference, the first half of the voltage period will hereinafter be indicated as positive voltage period A, while the second half of the voltage period will hereinafter be indicated as negative voltage period B.

The start of the positive voltage period A is indicated at time t₀. At this moment, positive current pulses are applied to a lamp, causing the lamp voltage to rise. The positive voltage period A ends at time t₁, at which moment the negative voltage period B begins. Similarly as described above, at time t₁ negative current pulses are applied to the lamp, causing the lamp voltage to rise to a negative level.

The negative voltage period B lasts until time t₂, after which the above cycle is repeated.

Thus, at all times during the entire voltage cycle, current pulses are generated, illustrated as spikes on the voltage curve.

A driver circuit of the above-referenced type suffers from drawbacks associated with the generation of current pulses. A first disadvantage relates to the fact that the current pulses are a source of EMI. A second disadvantage relates to the fact that switching losses are associated with each current pulse. On the other hand, as can be seen from FIG. 1, the lamp voltage does not change much during the later portions of the voltage period halves, whereas the generation of current pulses, and their associated disadvantages, continues.

It is an important objective of the present invention to reduce the disadvantages of the prior art. It is a specific objective of the present invention to provide a driver circuit with an improved efficiency. The invention is defined by the independent claims. The dependent claims define advantageous embodiments.

The present invention is based on the recognition that, since the lamp voltage does not change much during the later portion of each voltage period half, the current pulses may be omitted, thus avoiding the disadvantageous effects of the current pulses without much affecting the voltage level at the driver output.

In order to attain the above-mentioned objectives, and based on the above-mentioned recognition, an important aspect of the driver circuit proposed by the present invention is that current pulses are only generated during an initial portion of each positive or negative voltage period A, B and are inhibited during a final portion of each positive or negative voltage period. So, while the present invention may use the same hardware as the prior art, the difference is in the control scheme. A prior art solution would be to have a pulse width modulation (PWM) charge phase and a PWM discharge phase. In a preferred embodiment of the invention, there are four phases: a PWM charge phase, a non-PWM charge phase, a PWM discharge phase, and a non-PWM discharge phase. The advantage of this is a lower power consumption by having less PWM switching losses. This is particularly useful in mobile applications.

These and other aspects, features and advantages of the present invention will be further explained by the following description of a preferred embodiment of the driver according to the present invention with reference to the drawings, in which same reference numerals indicate same or similar parts, and in which:

FIG. 1 is a graph schematically illustrating a voltage waveform according to prior art;

FIG. 2 is a schematic block diagram of a driver;

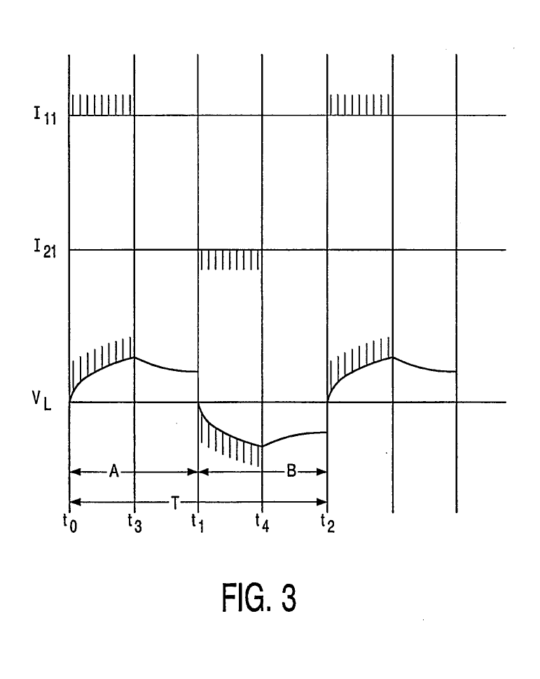

FIG. 3 is a graph schematically illustrating current and voltage in a driver according to the present invention;

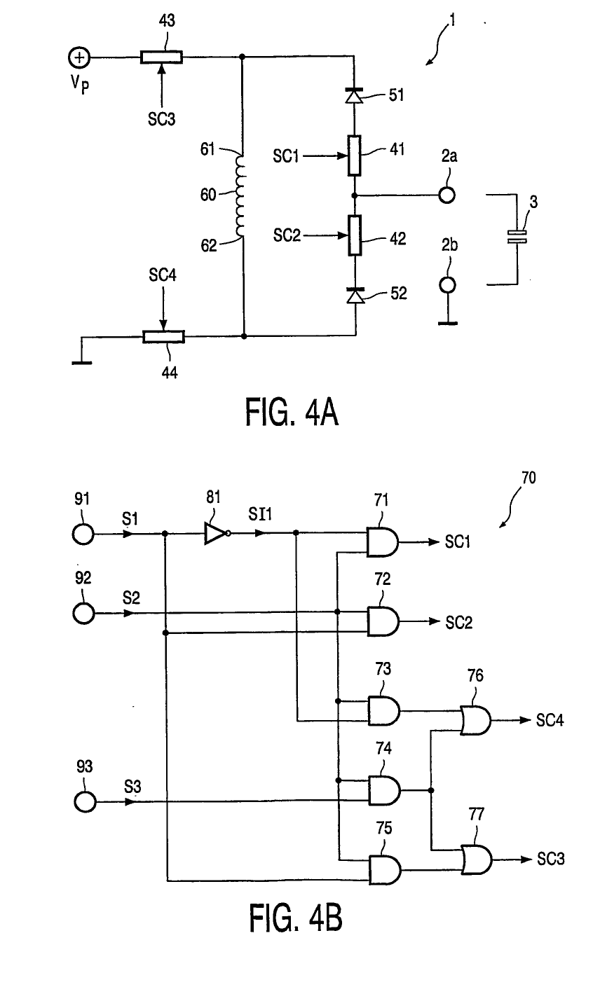

FIGS. 4A and 4B are block diagrams schematically illustrating exemplary embodiments of a driver according to the present invention; and

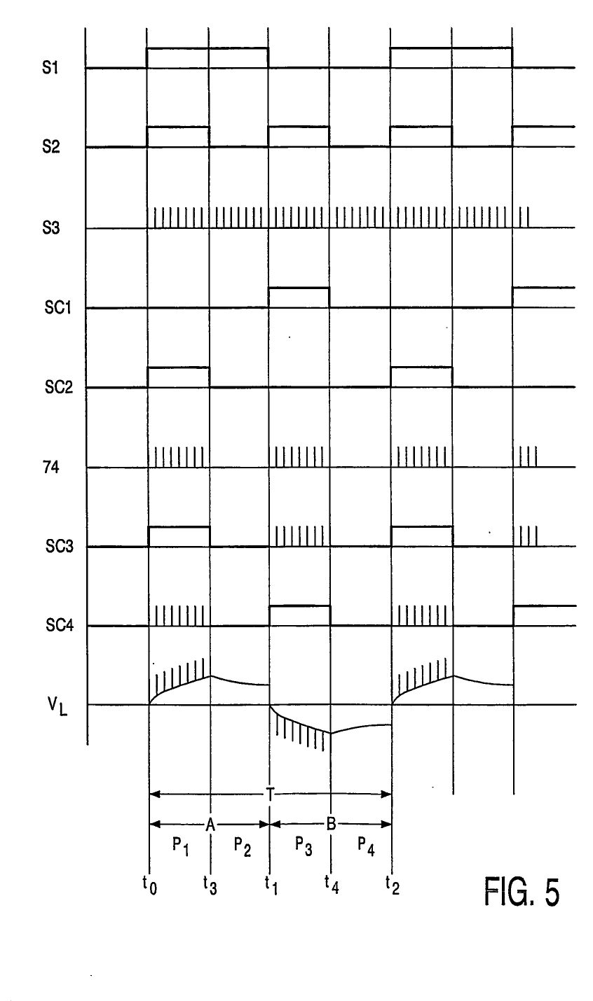

FIG. 5 is a timing diagram schematically illustrating signals in the driver according to FIGS. 4A-B.

FIG. 2 schematically illustrates a driver circuit 1, and FIG. 3 is a graph schematically illustrating its operation according to the present invention. The driver circuit 1 has an output 2. An electroluminescent lamp 3 is connected between the output 2 and a reference voltage level V_{R}, typically mass. A first inverter 11 is coupled to the output 2, the first inverter 11 being arranged for generating positive current pulses, for which purpose the first inverter 11 is associated with a first voltage source V_{P} generating a voltage at a level higher than said reference voltage level V_{R}. Similarly, a second inverter 21 is coupled to the output 2, being adapted to generate negative current pulses, for which purpose the second inverter 21 is associated with a second voltage source V_{N} generating a voltage at a level lower than said reference voltage level V_{R}. A control device 30 controls the operation of the inverters 11 and 21.

It is noted that it is not always essential that two voltage sources are present for generating voltages higher and lower than said reference voltage level. Depending on the implementation of the inverters it may suffice if the second voltage source V_{N} generates a voltage at a level lower than the first voltage source V_{P}; in such case, the second inverter 21 may for instance be coupled between output 2 and said reference voltage level V_{R} (mass).

FIG. 3 is a graph, showing the current pulses of the first inverter 11 at I₁₁, showing the negative current pulses of the second inverter 21 at I₂₁, and showing the output voltage at the output 2, i.e. the lamp voltage applied to the lamp 3, at V_{L}. Similarly as in FIG. 1, an overall lamp voltage period is indicated as T, a positive lamp voltage period is indicated as A, and a negative lamp voltage period is indicated as B.

The positive voltage period starts at time t₀. At that moment, the first inverter 11, under the control of the control unit 30, starts to generate positive current pulses I₁₁, which are applied to the lamp 3, as a result of which the lamp voltage V_{L} rises.

The positive voltage period A ends at time t₁. According to an important aspect of the present invention, no positive current pulses are applied to the lamp 3 in a final portion of the positive voltage period A between time t₃ and t₁, t₃ being between to and t₁. Preferably, t₃ is approximately halfway between t₀ and t₁ .

In a possible implementation, the first inverter 11 does not generate any current pulses in the period between t₃ and t₁, as illustrated in FIG. 3. In another possible implementation, the first inverter 11 continues generating positive current pulses, but means are provided for preventing the current pulses from reaching the output 2; this implementation is not illustrated.

As can be seen from FIG. 3, the lamp voltage level V_{L} decreases slightly in said final portion of the positive voltage period A between t₃ and t₁. However, the remaining voltage during this time interval from t₃ to t₁ is sufficient for sustaining the lamp 3. On the other hand, since no current pulses are generated in this time interval from t₃ to t₁, the above-mentioned disadvantages associated with current pulses are avoided. Thus, no EMI is generated, and no switching losses occur in said time interval from t₃ to t₁.

At t₁, the second inverter 21 starts, under control of the control unit 30, to generate negative current pulses I₂₁, which are applied to the output 2, causing the lamp voltage V_{L} to increase with a negative polarity. At t₄, between t₁ and t₂, and preferably halfway between t₁ and t₂, the second inverter 21, under control of the control unit 30, stops generating its current pulses. Similarly as described above, the lamp voltage V_{L} (now having a negative polarity) decreases slightly in the time interval from t₄ to t₂, but the (negative) voltage level remains sufficient to sustain the “burning” of the lamp 3.

In the above, it is explained that switching losses are associated with the current pulses, and that the efficiency of the driver circuit provided by the present invention has improved thanks to the fact that no switching losses occur in the time intervals from t₃ to t₁ and from t₄ to t₂. Switching losses also occur when the voltage polarity reverses, i.e. at times t₁, t₂, etc. It is a further advantage of the driver circuit proposed by the present invention that the voltage level V_{L} has slightly decreased in said intervals from t₃ to t₁ and from t₄ to t₂, because now the switching losses at times t₁, t₂, etc. are reduced.

In the embodiment schematically illustrated in FIG. 2, the first inverter 11 and the second inverter 21 are coupled to a common lamp electrode, the other lamp electrode being connected to a reference voltage level. However, as will be clear to a person skilled in the art, it is also possible that a first inverter is coupled to a first lamp electrode and that a second inverter is coupled to a second lamp electrode.

FIGS. 4A and 4B schematically illustrate a practical embodiment of the driver circuit according to the present invention. In the embodiment of FIGS. 4A and 4B, the two inverters are not completely separate as the inverters 11 and 21 discussed with reference to FIG. 2, but they have parts in common, as will be explained below.

In FIG. 4A, an inductor 60 has a first terminal 61 connected to the cathode terminal of a first diode 51, which has his anode terminal coupled to a first output terminal 2a via a first controllable switch 41, which is controlled by a first control signal SC1, as will be explained later. The inductor 60 has a second terminal 62 connected to the anode terminal of a second diode 52, whose cathode terminal is coupled to said first output terminal 2a via a second controllable switch 42, which is controlled by a second control signal SC2, as will be explained later. The first inductor terminal 61 is coupled to a positive voltage source V+ via a third controllable switch 43, which is controlled by a third control signal SC3, as will be explained later. The second inductor terminal 62 is coupled to a reference voltage source, in this case mass, via a fourth controllable switch 44, which is controlled by a fourth control signal SC4, as will be explained later. A second output terminal 2b is shown, connected also to said reference voltage, in this case mass.

As will be clear to a person skilled in the art, the controllable switches may be implemented for instance by transistors.

FIG. 4B shows a possible implementation of a control circuit 70 for generating the control signals for the controllable switches 41-44. Herein, it will be assumed that the switches are closed (i.e. they form a conductive path) if they receive a control signal above a first predetermined level (logical HIGH), and that the controllable switches are opened (i.e. they are not conductive) if they receive a control signal below a second predetermined level (logical LOW), wherein these two levels may be identical or different. However, it should be clear to a person skilled in the art that other implementations are possible, too.

The control circuit 70 shown in FIG. 4B comprises five AND-gates 71-75, two OR-gates 76-77, an inverter 81, and three signal sources 91-93. A first signal source 91 is arranged for generating a first low frequency signal S1. A second signal source 92 is arranged for generating a second frequency signal S2 having a frequency higher than the frequency of the first signal S1. Preferably, the frequency of the second low frequency signal S2 is twice the frequency of the first low frequency signal S1. In an exemplary embodiment, the first low frequency signal S1 has a frequency of 270 Hz, while the second low frequency signal S2 has a frequency of 540 Hz.

The first and second signal sources may be implemented by independent signal generators. However, in a preferred embodiment, the first signal S1 is derived from the second signal S2 by a divider, as is known per se.

The third signal source 93 is arranged for generating a relatively high frequency signal S3. Typically, the frequency of the high frequency signal S3 may be chosen in the range between 10 and 100 kHz. In an exemplary embodiment, the frequency of the third frequency signal S3 may be 20 kHz.

The second frequency signal S2 is applied to a first AND-gate 71, a second AND-gate 72, a third AND-gate 73, a fourth AND-gate 74 and a fifth AND-gate 75. The first frequency signal S1 is applied to the second AND-gate 72 and the fifth AND-gate 75. This first frequency signal S1 is also applied to said inverter 81, which provides an inverted first frequency signal SI1, which is applied to the first AND-gate 71 and the third AND-gate 73.

The output signal of the third AND-gate 73 is applied to a first terminal of a first OR-gate 76. Since the third AND-gate 73 receives the same input signals as the first AND-gate 71, its output signal is identical to the output signal of the first AND-gate 71. Therefore, in a simplified embodiment, the third AND-gate 73 could be omitted and the output signal of the first AND-gate 71 could be applied to the first OR-gate 76 instead.

The output signal of the fifth AND-gate 75 is applied to an input terminal of a second OR-gate 77. Since the input signals of the fifth AND-gate 75 are identical to the input signals of the second AND-gate 72, its output signal is identical to the output signal of the second AND-gate 72. Therefore, in a simplified embodiment, the fifth AND-gate 75 could be omitted and the output signal of the second AND-gate 72 could be applied to the second OR-gate 77 instead.

The high frequency signal S3 is applied to the fourth AND-gate 74, whose output signal is applied to both the first OR-gate 76 and the second OR-gate 77.

FIG. 5 shows the waveforms of the various signals. In FIG. 5, it is assumed that the first and second low frequency signals S1 and S2 are in phase.

The outputs of the first AND-gate 71 and the third AND-gate 73 are HIGH when the second signal S2 is HIGH while the first signal S1 is LOW. The output signal of the first AND-gate 71 is applied to the first controllable switch 41 as first control signal SC1.

The outputs of the second AND-gate 72 and of the fifth AND-gate 75 are HIGH when the second signal S2 is HIGH while the first signal S1 is HIGH. The output of the second AND-gate 72 is applied to the second controllable switch 42 as second control signal SC2.

The fourth AND-gate 74 effectively gates the high frequency signal S3 with the second low frequency signal S2. Thus, the output signal of the fourth AND-gate 74 is a high frequency signal during those periods when the second low frequency signal S2 is HIGH. The first OR-gate 76 adds the high frequency output signal of the fourth AND-gate 74 with the output signal of the third AND-gate 73, so that the output signal of the first OR-gate 76 is:
a high frequency signal during those periods that the second control signal SC2 is HIGH, and
a HIGH signal during those periods that the first control signal SC1 is HIGH. Similarly, the output signal of the second OR-gate 77 is:
a high frequency signal during those periods that the first control signal SC1 is HIGH, and
a HIGH signal during those periods that the second control signal SC2 is HIGH.

The output signal of the first OR-gate 76 is applied to the fourth controllable switch 44 as fourth control signal SC4, whereas the output signal of the second OR-gate 77 is applied to the third controllable switch 43 as third control signal SC3.

The operation of the driver circuit shown in FIG. 4A and 4B is as follows. In a first phase P₁ between t₀ and t₃, the second controllable switch 42 and the third controllable switch 43 are CLOSED (conductive), the first switch 41 is OPEN (non-conductive), and the fourth controllable switch 44 switches at the high frequency of the high frequency source 93. Thus, the driver circuit now operates as up-converter. Positive current pulses are applied to an electroluminescent lamp 3 connected to the output terminals 2a and 2b, causing the voltage level V_{L} at the output terminal 2a to rise.

In a second phase P₂ between t₃ and t₁, all switches 41-44 are OPEN (non-conductive), and the output voltage V_{L} at the output terminal 2a slowly decreases.

At time t₁, the first controllable switch 41 and the fourth controllable switch 44 close (become conductive) and the third controllable switch 43 is switched at the high frequency of the high frequency source 93. As soon as the first and fourth controllable switches 41 and 44 are both conductive, the electroluminescent lamp 3 is discharged via switch 41, diode 51, inductor 60 and switch 44. The amount of energy to be discharged has decreased in view of the decreasing voltage level in phase P₂.

During a third phase P₃ between t₁ and t₄, the first controllable switch 41 and the fourth controllable switch 44 remain CLOSED (conductive), the second controllable switch 42 remains OPEN (non-conductive), and the third controllable switch 43 switches at the high frequency of the high frequency source 93. Thus, the driver circuit now operates as inverting converter or flyback converter. As long as the third controllable switch 43 is conductive, a current through switch 43, inductor 60 and switch 44 increases. When the third controllable switch 43 becomes non-conductive, the diode 51 starts to conduct and the output terminal 2a is drawn to a negative potential.

During a fourth phase P₄ between t₄ and t₂, all switches 41-44 are OPEN (non-conductive) again, and the output voltage V_{L} at the output terminal 2a slowly decreases. At time t₂, the above cycle is repeated.

It should be clear to a person skilled in the art that the present invention is not limited to the exemplary embodiments discussed above, but that various variations and modifications are possible within the protective scope of the invention as defined in the appending claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Driver for an electroluminescent lamp, comprising:
an output for connecting the electroluminescent lamp;
first current pulse generating means for generating at the output current pulses having a first polarity;
second current pulse generating means for generating at the output current pulses having a second polarity opposite the first polarity;
control means operatively coupled to the first and second current pulse generating means, to switch the first and second current pulse generating means ON and OFF; wherein the control means are adapted to switch both first and second current pulse generating means OFF during at least one portion of an output voltage period.

2. Driver according to claim 1, wherein the control means are adapted to:
during a first phase, maintain the first current pulse generating means in an ON state and maintain the second current pulse generating means in an OFF state;
during a second phase following the first phase, maintain the first current pulse generating means in an OFF state and maintain the second current pulse generating means in an OFF state;
during a third phase following the second phase, maintain the first current pulse generating means in an OFF state and maintain the second current pulse generating means in an ON state;
during a fourth phase following the third phase, maintain the first current pulse generating means in an OFF state and maintain the second current pulse generating means in an OFF state.

3. Driver according to claim 2, wherein the duration of the second phase is approximately equal to the duration of the first phase, and wherein the duration of the fourth phase is approximately equal to the duration of the third phase.

4. Driver according to claim 2, wherein the duration of the third phase is approximately equal to the duration of the first phase.

5. Driver according to claim 1, comprising:
an inductor;
a series arrangement of a first diode and a first controllable switch coupled between a first terminal of said inductor and a first output terminal, the first diode having its anode directed towards said first output terminal;
a series arrangement of a second diode and a second controllable switch coupled between a second terminal of said inductor and said first output terminal, the second diode having its cathode directed towards said first output terminal;
a third controllable switch coupled between said first terminal of said inductor and a first voltage source;
a fourth controllable switch coupled between said second terminal of said inductor and a second voltage source; control means adapted to generate control signals for controlling said switches.

6. Driver according to claim 5, wherein said control means is adapted to generate control signals such that all said switches are maintained in a non-conductive state during at least one portion of an output voltage period.

7. Driver according to claim 6, wherein said control means is adapted to generate control signals such that:
during a first phase, the first controllable switch is in a non-conductive state, the second and third controllable switches are in a conductive state, and the fourth controllable switch is switched ON/OFF at a relatively high frequency;
during a second phase following the first phase, all said switches are maintained in a non-conductive state;
during a third phase following the second phase, the second controllable switch is in a non-conductive state, the first and fourth controllable switches are in a conductive state, and the third controllable switch is switched ON/OFF at a relatively high frequency;
during a fourth phase following the third phase, all said switches are maintained in a non-conductive state.

8. Driver according to claim 7, wherein said control means comprise:
a first signal source arranged for generating a first low frequency signals;
a second signal source arranged for generating a second low frequency signal having a frequency higher than the frequency of the first signal;
a first AND gate coupled to receive the second low frequency signal and the inverted first low frequency signal, providing the first control signal for the first controllable switch;
a second AND gate coupled to receive the second low frequency signal and the first low frequency signal, providing the second control signal for the second controllable switch.

9. Driver according to claim 7, comprising:
a third signal source arranged for generating a relatively high frequency signal;
a fourth AND gate coupled to receive the second low frequency signal and the relatively high frequency signal;
a third AND gate coupled to receive the second low frequency signal and the inverted first low frequency signal;
a fifth AND gate coupled to receive the second low frequency signal and the first low frequency signal;
a first OR gate coupled to receive the output signals of the third and fourth AND gates, providing the fourth control signal for the fourth controllable switch;
a second OR gate coupled to receive the output signals of the fifth and fourth AND gates, providing the third control signal for the third controllable switch.

10. Driver according to claim 8, wherein the frequency of the second low frequency signal is twice the frequency of the first low frequency signal.

11. Electroluminescent lamp arrangement, comprising:
an electroluminescent lamp; and
a driver for the electroluminescent lamp as claimed in claim 1.

12. Method for driving an electroluminescent lamp, the method comprising:
in a first phase, feeding the lamp with current pulses of a first polarity;
in a third phase, feeding the lamp with current pulses of a second polarity opposite the first polarity;
wherein a substantially pulse-free second phase is present between the end the first phase and the start of the third phase.
